(19) United States
(12) Patent Application Publication
(10) Pub. No.: US 2005/0190536 A1
(43) Pub. Date: Sep. 1, 2005

(54) Method for expanding PC functionality while maintaining reliability and stability

(75) Inventors: Jason Michael Anderson, Snoqualmie, WA (US); William Jefferson Westerinen, Sammanish, WA (US); Kenneth W. Stufflebeam JR., Monroe, WA (US)

Correspondence Address: WOODCOCK WASHBURN LLP, ONE LIBERTY PLACE - 46TH FLOOR, PHILADELPHIA, PA, 19103, US

(73) Assignee: Microsoft Corporation

(21) Appl. No.: 10/787,798

(22) Filed: Feb. 26, 2004

(51) Int. Cl. G06F 1/16

(52) U.S. Cl. 361/686

(57) ABSTRACT

The present invention is directed to systems and methods for providing a computing system have a base unit and an expansion unit. The base unit has a fixed configuration and includes a CPU, a power supply, a removable media drive and expansion slots. The expansion unit has a power supply, removable media drive, and expansion slots. Additional components are added to the expansion unit in order to maintain stability in the base unit and the expansion unit is connected to the base unit by a high speed external connection. This configuration provides for an expansion path for the computing system that maintains overall stability of the base unit.

### FIELD OF THE INVENTION

This invention generally relates to the field of computing devices. More particularly, this invention relates to a system and method of providing an expansion path for a personal computer that maintains overall system stability and reliability as devices are added to the computer.

### BACKGROUND OF THE INVENTION

Present day personal computers (PC) are not much different than they were over 20 years ago when the PC was first introduced. PCs were designed to be expandable devices allowing the user or OEM to create many different offerings using the same basic platform as a foundation. While this level of flexibility has provided a basis for the PC's success, it has also caused problems, such as instability, complexity and cost that have not been adequately addressed.

Expandability creates instability issues because it is impractical to test every possible combination of PC components together with one another. The problems arise when users upgrade the base PC, thereby changing the shipping configuration that was extensively tested by the OEM, compromising stability. Seemingly, as soon as one bug arises and is fixed, another bug surfaces once other components are added and removed. As such, OEMs typically only test base PC configurations.

The numerous expansion options internal to the PC chassis create complexity within the PC. This requires the user to have some mechanical knowledge of PC architecture in order to be able to properly install a new device without damaging the component. In addition, some electrical knowledge is also necessary to ensure the user does not introduce unwanted electrostatic discharge into components that are sensitive resulting in component damage. The user may also inadvertently come into contact with high-current devices inside of a PC chassis which could result in electrical shock to the user.

In customizing a system prior to shipment, OEMs bear the cost of expansion components which have a higher cost than their integrated counterparts. The OEMs also bear the cost of assembling the components into the PC. Adding cost to an entry-level PC is not practical, as manufacturers attempt to strike certain price points. Therefore, either the systems ship without a particular functionality with the expectation that users will later upgrade (leading to the instability and complexity issues articulated above), or the system is sold at a higher price point, elevating the OEM's inventory risk if they cannot sell all of their inventory.

While external expansion capabilities have been available on the PCs for years, they have been plagued by low bandwidth, making them impractical for high data rate devices, such as hard disk drives or graphics adapters. Recent developments have increased bandwidth for external expansion busses making external expansion for most devices on the PC platform possible, however, external expansion capabilities have also attributed to some level of complexity. For example, every external device that is added to the system is individually connected to the PC (or daisy-chained together if IEEE1394) resulting in unwanted desktop clutter and many cables.

Thus, there is a need for a system and method making expansion of PCs easier and that enables OEMs to deliver an entry-level PC that is upgradeable, while maintaining stability, delivering low acoustics, a compelling industrial design, and that increases consumption of PCs by cost-sensitive buyers. The present invention provides such a solution.

### SUMMARY OF THE INVENTION

The present invention is directed to systems and methods for providing a computing system have a base unit and an expansion unit. The base unit has a fixed configuration and includes a CPU, a power supply, a removable media drive and expansion slots. The expansion unit has a power supply, removable media drive, and expansion slots. Additional components are added to the expansion unit in order to maintain stability in the base unit and the expansion unit is connected to the base unit by a high speed external connection.

According to a feature of the invention, the base unit and the expansion unit are connected via a PCI Express connection. The base unit may also include an expansion slot for a video card.

According to another feature, the expansion unit includes card slots and server I/O slots. Optionally, the expansion unit may include a docking connector to dock a mobile computer to the expansion unit.

According to yet another feature, the expansion includes a video card that provides a video out for a computer monitor and a television. If the expansion unit includes a CPU, it may be adapted to perform computing functions without being connected to the base unit.

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram showing a conventional personal computer;

FIG. 2 is a block diagram showing a block diagram overview of the present invention;

FIG. 3 is a block diagram showing a mobile personal computer docked to an expansion unit in accordance with the present invention;

FIG. 4 is a block diagram showing a gaming console incorporated into an expansion unit in accordance with the present invention;

FIGS. 5-10 are block diagrams showing an embodiment of the present invention where a separate processor module having a processor, memory and north bridge is provided; and

FIG. 11 is an embodiment wherein the expansion module includes a gaming console module and gaming console.

### DETAILED DESCRIPTION OF PREFERRED EMBODIMENTS

A Convention Personal Computer

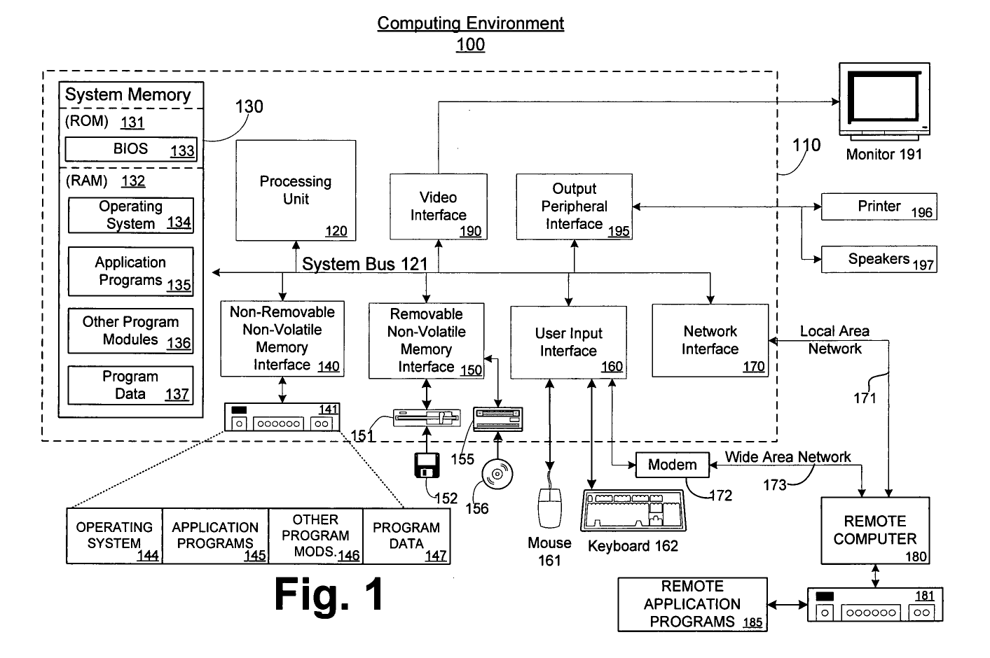

FIG. 1 illustrates an example of a conventional personal computer system environment 100. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus), Peripheral Component Interconnect Express (PCI-Express), and Systems Management Bus (SMBus).

Computer 110 typically includes a variety of computer readable media. Computer readable media can be any available media that can be accessed by computer 110 and includes both volatile and non-volatile media, removable and non-removable media. By way of example, and not limitation, computer readable media may comprise computer storage media and communication media. Computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or non-volatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/non-volatile computer storage media. By way of example only, FIG. 1 illustrates a hard disk drive 141 that reads from or writes to non-removable, non-volatile magnetic media, a magnetic disk drive 151 that reads from or writes to a removable, non-volatile magnetic disk 152, and an optical disk drive 155 that reads from or writes to a removable, non-volatile optical disk 156, such as a CD-ROM or other optical media. Other removable/non-removable, volatile/non-volatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Exemplary System for Expanding Functionality of a Computing Device

The present invention is directed to a personal computer that is, e.g., an entry-level PC with external expansion capabilities that preserve stability of the base PC in addition to decreasing complexity.

The processes that manufacturers (OEMs) use to decide market segments in to which they will sell PCs into is decided through generative and evaluative research. Features that are determined to be necessary on a base platform are included in the base entry level system itself, as well as higher-end systems. The following is an example of a system that is designed for the entertainment space of the home. While the example below is provided for exemplary purposes, it is not exclusive to this embodiment, and as such, shall not be deemed to be limiting.

For a PC designed for the entertainment room of a consumer's home, it is preferable to have the following base requirements: instant On/Off, low acoustic emissions, a DVD-ROM drive, an 80 GB hard disk drive, integrated graphics with TV-out capability, analog stereo audio out, and a remote user interface (e.g., remote control) in addition to keyboard and mouse for navigation and input. This configuration provides a user experience that allows the user to use the PC from their couch with the TV as the display. Base usage scenarios include watching DVD movies, playing games, listening to audio, and viewing photos.

If the user desires to perform additional functions beyond the base configuration, the user must purchase the peripherals necessary to support these scenarios. Such scenarios include PVR functions (i.e., record live television or record movies to DVD±RW), adding 5.1 Dolby surround sound and S-Video, or playing high-end computer games. However, adding functionalities may lead to the problems of complexity and instability discussed above.

In order to overcome the limitations of the prior art, the present invention is directed to a new PC architecture that enables OEMs to provide another small chassis (“expansion unit” or “expansion module”), that connects to the main PC (“base unit” or “base module”) through USB 2.0, IEEE1394 or PCI Express. The expansion unit provides the ability for the user to add components as necessary to fill their particular needs on a piece-by-piece fashion. The expansion unit itself is preferably a device with the mechanicals to support easy addition of peripherals.

In addition to overcoming the problems of complexity, stability and cost, the present invention also provides the following benefits. By separating the expansion functions from the base PC unit, the OEM can design a stable, sealed system having a power supply that is targeted for power consumption of the base PC. This eliminates the need for an extra-large power supply to power all of the devices that are installed into the expansion unit. By sizing the power supply appropriately for the base PC unit, the base PC unit will be more energy efficient and produce less heat, thereby decreasing the need to cool the system with noisy fans. Instead, fans can be designed and placed optimally for the base PC unit enabling a very quiet PC in full running operation.

In addition, by removing the physical space necessary in the PC to accommodate full length and height PCI cards as well as the larger power supply, the system designer can design a much smaller system than conventional “standard ATX” systems. This enables the OEM to potentially sell into markets that previously would not have been acceptable due to size, noise and complexity. OEMs may also use this design point as an opportunity to introduce a low cost PC, with a product roadmap that enables the customer to easily expand this system in the future. This also provides consumers with comfort in knowing that their investment in the base PC is protected as they can easily upgrade it in the future.

The present invention may be implemented in a number of ways that may have different technical requirements or form factors required to support them. It is assumed that the following features would be preferred by users and may be shared among all embodiments.

1. Personal Video Recording—This feature implies that an additional hard disk drive, TV Tuner card as well as an optional DVD±RW, DVD-R, CD+RW or CDR drive are provided in the expansion unit.

2. Network-Attached Services—This feature includes the ability for services located in the expandability unit to be available to other computers on the network when the PC is both present or potentially removed (as in the case of a portable PC). Such services include, but are not limited to: a content server for Digital Media Receivers, a file server for data serving, print services, a Wireless Access Point, Network Address Translator/DHCP router, and a network firewall.

3. Graphics/Audio upgrades for the host PC (base unit).

4. Set top box functionality.

5. RunTime Control (RTC) / telephone services—This feature provides for telephony services, such as, Voice over IP (VOIP), Burst Tolerance (BT), Plain Old Telephone Service (POTS), Personal Branch Exchange (PBX), answering machine, and caller ID.

6. Digital Media Receiver.

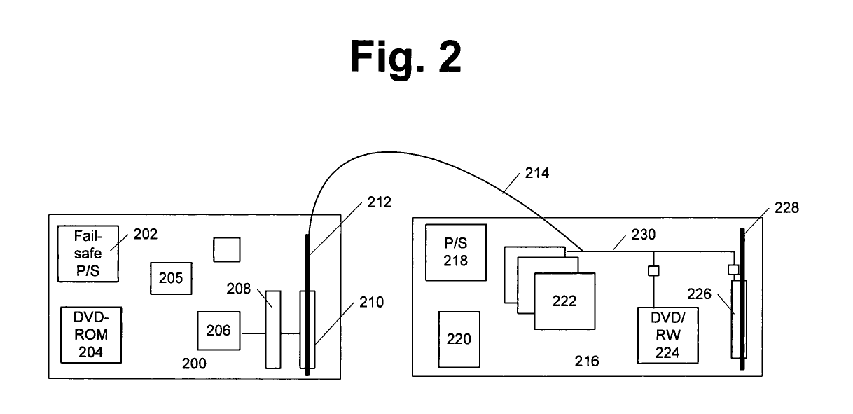

Referring now to FIG. 2 there is illustrated a first embodiment of the present invention. The base PC unit 200 may be a sealed-box as described earlier allowing the expansion unit 216 to be the point of differentiation for the OEM. While both USB and IEEE1394 may be used to connect the expansion unit 216 to the base PC unit 200 to satisfy most of the needs described above, it is preferable to utilize PCI Express as a connection between the base PC unit 200 and the expansion unit 216. The PCI Express specification is described in PCI Express Base 1.0a Specification, published by PCI-SIG, Portland, Oreg., and are incorporated herein by reference in its entirety.

As shown in FIG. 2, the base PC unit 200 includes a power supply 202 sized for the power demands of the base unit 200, a DVD-ROM (removable media) drive 204, and a processor 205. A chipset 206 controls the central functions of the base PC unit 200, including: a cache for instructions, a controller for handling memory, bus interface logic, and data path functions. The chipset 206 preferably incorporates PCI Express. A limited number of PCI Express expansion slots are provided, such as a video slot 208, and a slot 210 for a bridge card 212. The bridge card 212 provides a connection for a PCI Express cable 214 that connects to the expansion unit 216. The PCI Express cable 214 may include x2 to x16 lanes.

The expansion unit 216 includes its own power supply 218 and ExpressCard slots 220. ExpressCard is proposed by PCMCIA and is expected to replace CardBus as the preferred solution for I/O technology add-ons to desktops and mobile computers. The ExpressCard slots 220 allow for the addition of wireless cards, and digital media (i.e., flash, removable hard drives, etc.). PCI Express Server I/O Slots 222 provide for additional expansion via cartridges. Cartridges such as an AC 97 5.1, a 5.1 amplifier, hard drives, and microprocessor and USB connections may be added via the PCI Express Server I/O Slots 222. The expansion unit may also include a DVD±RW drive 224, and PCI Express expansion slots 226 connected to a PCI Express backplane 230 to accommodate, e.g., a TV tuner, graphics card, or other PCI cards 228. Optionally, conventional PCI slots may be provided.

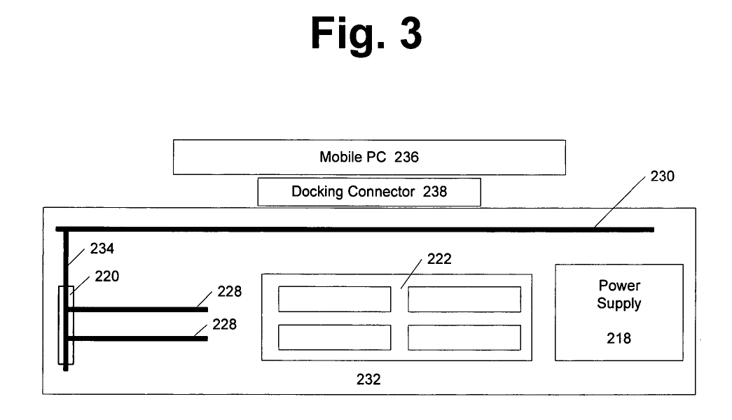

Referring now to FIG. 3, in accordance with another embodiment, a mobile computer 236 may serve as the base PC unit, and an expansion unit 232 includes a docking connector 238 connected via PCI Express. While the form factor of the expansion unit 232 may be different than that of expansion unit 216 in FIG. 2, they both may contain similar components (e.g., the power supply 218, PCI Express Server I/O Slots 222, PCI cards 228). The expansion unit 232 may utilize a PCI riser card 234 within slot 220 that connects the PCI cards 228 to the PCI Express backplane 230. The expansion unit 232 may also include it own CPU.

By docking the mobile PC 236 into the expansion unit 232, the graphics rendering may transition over to an internal PCI Express video card in the expansion unit 232 to enable high-end graphics. Alternatively, a gaming console may be the main control point rather than the mobile PC 236. While the gaming console most likely will not be removed from the expansion unit 232 like the mobile PC, it would not have to be ON all of the time in order for the expansion unit to be able to function as, e.g., a PVR.

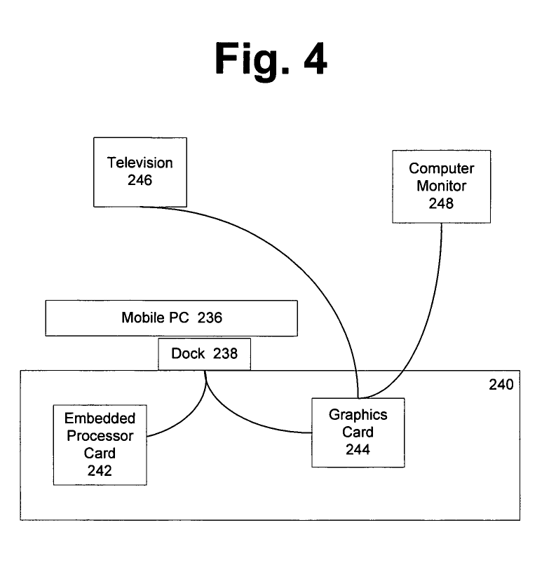

Referring to FIG. 4, there is illustrated a mobile media PC design. Docking the mobile PC 236 into the expansion unit 232 may enable it as high-end Media Center PC by providing a TV Tuner, extra HDD and DVD±RW to TV viewing (via television 246 and graphics card 244) and recording in the expansion unit 232. This embodiment also provides some level of processing (via processor 242) when the mobile PC 236 is not present to allow functions, such as PVR, to be executed even if the laptop is not physically present. Optionally, a computer monitor 248 may be connected to the graphics card 244.

Referring now to FIGS. 5-10, there is illustrated another embodiment of the present invention. According to this embodiment, the CPU 258, memory 260, display connector 262 and the north bridge 264 (i.e., the part of the chipset that that connects the CPU to the major interfaces on the computer including memory, AGP port and PCI bus) are on a module 256 containing PCI Express within an expansion unit 254. This design disaggregates the CPU 258, memory 260 and north bridge 264 from the rest of the PC architecture, thus allowing the user to upgrade components in the expansion module 254, while maintaining their hardware investment in the base module 250.

According to the embodiment of FIGS. 5 and 7-10, the PCI Express cable is contained within the expansion module 254, which enables, e.g., a graphics upgrade without burdening the user with full a 16-lane PCI Express cable extending out of the expansion module 254 (i.e., this design reduces the size of the cable external of the expansion module 254). Also, this embodiment enables processor and memory upgrades, and PCI Express bus 252 upgrades without significant end user trouble. In the embodiment of FIG. 5, the base module 250 is bootable.

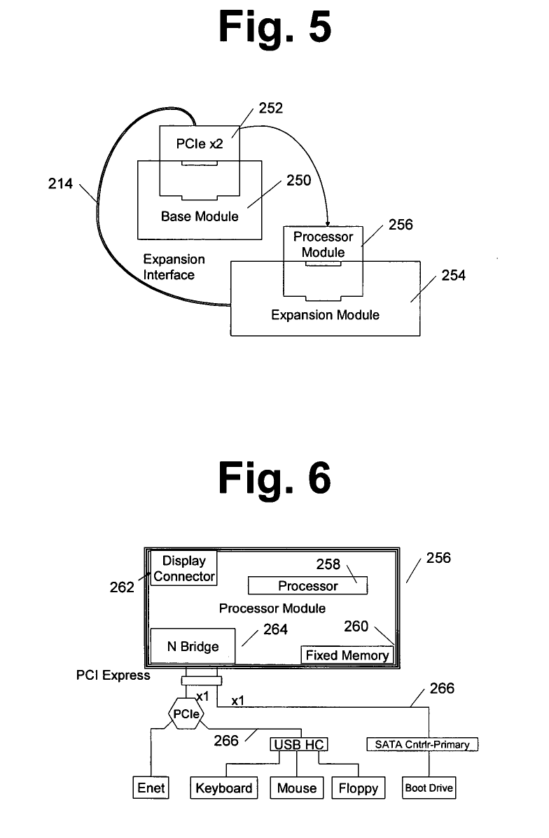

FIG. 6 illustrates an embodiment in which there is no expansion module. All functions are contained within the base module 250 and processing module 256. In this embodiment, two external PCI Express lanes 266 are used for devices, such as an Ethernet connection, a USB connection for a keyboard, mouse, floppy drive, and a boot drive.

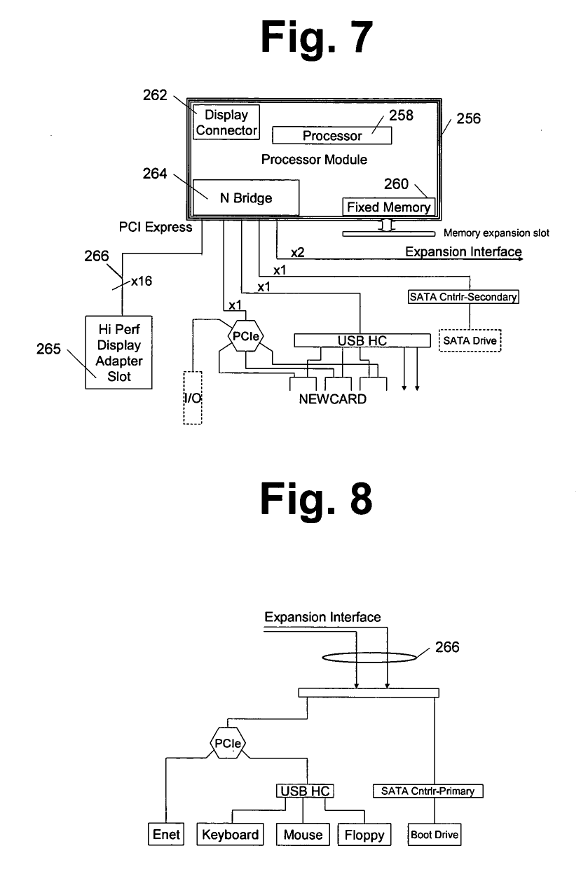

Referring to FIGS. 7 and 8, there is illustrated another embodiment where 16 PCI Express lanes 266 are provided to connect to a high performance video adapter slot 165, one PCI Express lane for a PCIe switch (connected to ExpressCard slots and other I/O devices), one PCI Express lane for a USB hub, one PCI Express lane for a serial ATA drive, and two addition PCI Express lanes that connect to the base module 250. The base module 250 is illustrated in FIG. 8, where the two PCI Express lanes connect to an Ethernet connection, a USB connection for a keyboard, mouse, floppy drive, and a boot drive.

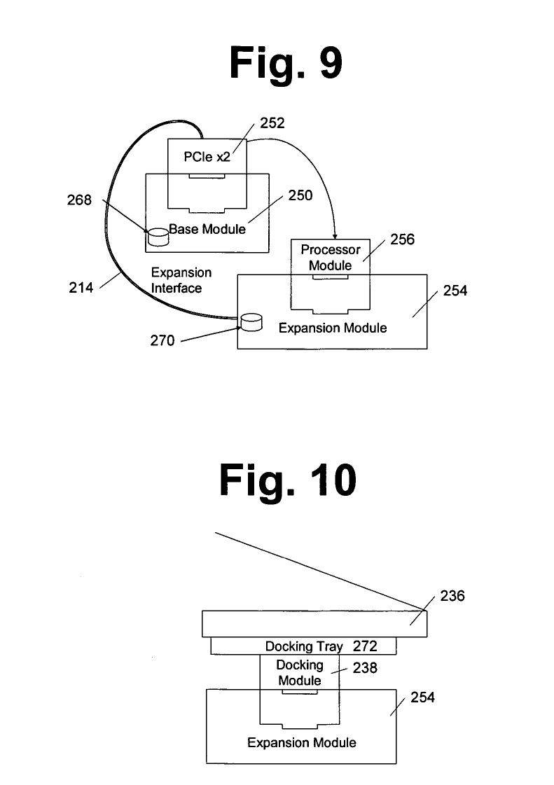

Referring to FIG. 9, there is illustrated an embodiment were the operating system 268 and software 270 are maintained within the base module 250 and expansion module 254, respectively. In this embodiment, OEMs may lock-down the operating system 268 and/or software 270 to further reduce instability, complexity and cost.

Referring to FIG. 10, there is illustrated the expansion module 254 in combination with the docking module 238 and a docking tray 272. The docking tray 272 may be used to dock multiple, different mobile PCs 236. The docking module 238 may include an embedded processor that allows the expansion module 254 to operate as a PVR.

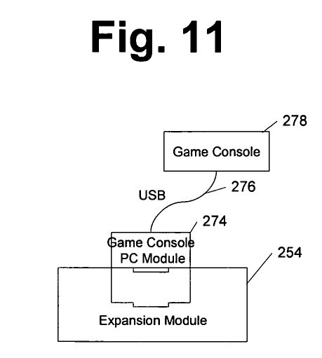

Referring to FIG. 11, there is illustrated another embodiment wherein the expansion module 254 receives a game console/PC module 274 that communicates to a game console 278 via a USB connection 276. The expansion module 254 may include an embedded processor that allows the expansion module 254 to operate as a PVR.

While the present invention has been described in connection with the preferred embodiments of the various Figs., it is to be understood that other similar embodiments may be used or modifications and additions may be made to the described embodiment for performing the same function of the present invention without deviating therefrom. For example, one skilled in the art will recognize that the present invention as described in the present application may apply to any computing device or environment, whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

1. A computing system, comprising:
a base unit having a CPU, a power supply, a removable media drive and expansion slots; and
an expansion unit having a power supply, removable media drive, and expansion slots,
wherein said base unit has a fixed configuration and additional components are added to said expansion unit, and wherein said expansion unit is connected to said base unit by a high speed external connection.

2. The computing system of claim 1, wherein said base unit and said expansion unit are connected via a PCI Express connection.

3. The computing system of claim 1, wherein said base unit includes an expansion slot for a video card.

4. The computing system of claim 1, wherein said expansion unit includes card slots and server I/O slots.

5. The computing system of claim 1, wherein said expansion unit further comprises a docking connector to dock a mobile computer to said expansion unit.

6. The computing system of claim 5, wherein said expansion unit comprises a video card, said video card providing outputs for a computer monitor and a television.

7. The computing system of claim 5, wherein said expansion unit comprises a CPU, and wherein said expansion unit is adapted to perform computing functions without being connected to said base unit.

8. A computing system, comprising:
a base unit having a CPU, a power supply, a removable media drive, expansion slots and a PCI Express bus; and
a processor module having a CPU, north bridge, fixed memory, and a PCI Express bus,
wherein external connections are provided via said PCI Express connection to said processor module.

9. The computing system of claim 8, wherein a display adapter is provided via said PCI Express bus to said processor module.

10. The computing system of claim 8, further comprising an expansion unit having a power supply, removable media drive, and expansion slots, wherein said expansion unit is connected to said processor module via said PCI Express bus.

11. The computing system of claim 10, wherein said base unit is bootable and said expansion unit is provided with a hard disk drive and a CPU, and wherein said expansion unit is adapted to perform computing functions without being connected to said processor module.

12. The computing system of claim 10, further comprising a docking connector.

13. The computing system of claim 8, wherein said base unit comprises a gaming console.

14. A method of providing expanding a computing system having a base unit, comprising:
fixing a configuration of said base unit;
providing a high speed external connection to an expansion unit from said base unit; and
adding additional components to said expansion unit.

15. The method of claim 14, wherein said high speed external connection comprises a PCI Express connection.

16. The method of claim 14, further comprising providing a docking connector to dock a mobile computer to said expansion unit.

17. The method of claim 14, wherein said expansion unit comprises a video card, said method further comprising providing a video out for a computer monitor and a television.

18. The method of claim 14, further comprising:
providing a CPU within said expansion unit; and
performing computing functions within said expansion unit without being connected to said base unit.
